(19) United States
(12) Patent Application Publication
(10) Pub. No.: US 2006/0175587 A1
(43) Pub. Date: Aug. 10, 2006

(54) Reaction product of a phosphorous acid with ethyleneamines for flame resistance

(76) Inventor: Maya Meltzer Kasowski, West Chester, PA (US)

Correspondence Address: RATNERPRESTIA, P.O. BOX 1596, WILMINGTON, DE, 19899, US

(21) Appl. No.: 10/547,855

(22) PCT Filed: Jun. 3, 2003
(86) PCT No.: PCT/US03/17268

§ 371 Date: Sep. 2, 2005

Related U.S. Application Data
(60) Provisional application No. 60/452,337, filed on Mar. 5, 2003.

(51) Int. Cl. C09K 21/00

(52) U.S. Cl. 252/601

(57) ABSTRACT

Flame retardant compositions, and compositions that comprise an organic polymer and the flame retardant composition are disclosed. The flame retardant compositions are prepared by reacting ethylene diamine with polyphosphoric acid; or reacting an ethyleneamnine or a mixture of ethyleneamines with phosphoric acid, polyphosphoric acid, pyrophosphoric acid, or mixtures thereof. A 10% by weight solution of the product in water has a pH between about 2.5 to 6.0. The flame retardant compositions are non-halogen containing flame retardant compositions and do not gas undesirably during processing at temperatures of 235° C. or even higher.

### CROSS-REFERENCE TO RELATED APPLICATIONS

This application claims priority of U.S. Provisional Application 60/452,337, filed Mar. 5, 2003.

### FIELD OF INVENTION

This invention relates to flame retardant compositions as well as a method for the preparation of the flame-retardant composition. Compositions that comprise an organic polymer and the flame retardant composition are also disclosed.

### BACKGROUND OF INVENTION

Flame-retardants that work via intumescence usually do not contain halogens. The flame-retardant mechanism of intumescence has been reviewed. (For a review of intumescence in coatings and polymers: D. G. Brady, et al. J. Fire Retardant Chemistry, 4, 150 (1977)). The intumescent flame retardant mechanism requires an inorganic acid source, a carbon source such as a polyhydric material like dipentaerythritol, and a blowing agent, which is often an amine like urea or melamine. Optionally, a halogen containing compound can be added for better activity. For coatings, the flame retardant includes the following types of compounds: a mineral acid salt such as sodium phosphate or practically water insoluble ammonia polyphosphate, a polyol such as starch, pentaerythritol, or dipentaerythritol, and a blowing agent such as melamine. The theory is that in a fire, the heat causes the mineral acid salt to decompose to form an acid, the acid dehydrates the polyol to form char, and the blowing agent decomposes to gaseous products. The result is char and gas that forms a foam that is much thicker than the original article or coating containing these flame retardants. A sequence of events with respect to formation of acid, dehydration of polyol, and release of gas must occur in the correct order and time sequence for the gas and char to form a protective foam. Different polymers may require different ingredients or amounts of ingredients to achieve similar levels of flame retardation. Thus, different mineral acid salts, polyols, or blowing agents are used in different applications, and there is no universal recipe.

Intumescence can be difficult to achieve in practice. It is often difficult for three or more ingredients to be well mixed in applications such as flame retarding a polymer. Good mixing of three ingredients in coating applications can be difficult if the ratio of solids content to solvent is very high. It is much more difficult to flame retard a polymer with three ingredients, because the above intumescence agents are added to the polymer melt. Relatively high viscosity of the polymer melt prevents easy mixing of flame retardants to obtain a homogeneous mix and good performance. Mixing a melted polymer for a long time to obtain a good dispersion of the flame retardants is unacceptable as the polymer can degrade if held above melt temperature too long. The flame resistance of polyolefins such as polypropylene can be improved by adding melamine pyrophosphate (MPP) and dipentaerythritol. (as taught in U.S. Pat. No. 3,936,416, 1976). This patent teaches that multiple components need be mixed into the polypropylene for good flame retardant performance via intumescence, as melamine pyrophosphate by itself requires too high a loading. Flame retardant performance will be dependent on uniformity of mixing of the components melamine pyrophosphate and dipentaerythritol into polypropylene. A single compound flame retardant would be easier from a mixing standpoint as maintaining the flame retardant in close proximity and balance throughout would not be as crucial. For plastics in general, it is difficult to disperse the ingredients as each ingredient may disperse differently or even agglomerate in the polymer melt. Therefore, a need exists for a single compound that performs all the tasks of the mineral acid salt, the polyol, and the blowing agent and is generally applicable to a variety of polymers.

Ethylene diamine phosphate (EDAP), which has some intumescence, is an excellent flame retardant for olefins such as polypropylene. Unfortunately, commercial extruders process polypropylene at about 235° C. which is too high a temperature to safely use EDAP without extensive ventilation to capture ethylene diamine that is released. Thus, it would be most desirable to make flame retardants that are more stable than EDAP and which would be good flame retardants for polymers such as polypropylene. Flame retardants such as EDAP require special conditions on commercial extruders to be used without decomposition. A flame retardant that is stable under standard processing conditions is highly desirable.

Thus, a need exists for more temperature stable flame retardant composition for olefins and other polymers that does not gas undesirably during processing, and which can be machine processed at temperatures 235° C. or even higher. Engineering polymers such as nylon 6, nylon 66, polyethylene terephthalate, polybutylene terephthalate, and polycarbonate process at temperatures greater than 235° C., which this invention addresses.

### SUMMARY OF INVENTION

This invention provides flame retardant compositions that provide flame retardation for a variety of applications, such as replacement of flame retardants containing halogens. The flame retardant used in many applications contain brominated or chlorinated compounds. There is a ready market for flame retardants that do not contain halogens, which this invention addresses.

This invention is a composition comprising:
a) 30 to 99.75 percent by weight of a polymeric material; and
b) 0.25 to 70 percent by weight of a flame retardant composition prepared by the method of:
reacting ethylene diamine with polyphosphoric acid; or
reacting an ethyleneamine or a mixture of ethyleneamines with an acid selected from the group consisting of phosphoric acid, polyphosphoric acid,
pyrophosphoric acid, and mixtures thereof;

in which the ratio of the acid or acid mixture to the ethylene diamine, the ethyleneamine, or mixture of ethyleneamines is such that a 10% by weight solution of b) in water has a pH between about 2.5 to 6.0.

The composition of this invention additionally comprises the step of addition of (1) 0.05 to 1% of an anti drip agent relative to weight of composition, (2) 4.0 to 50%, by weight of composition, amines selected from the group consisting of melamine, melamine phosphate, dimelamine phosphate, melamine pyrophosphate, melamine polyphosphate, or (3) a mixture thereof Other amines and their salts are effective as well.

The flame retardant composition can be prepared by a method additionally comprising the steps of initially reacting melamine with the acid or mixture of acids so that the pH of a 10% solution in water of the product formed thereby is less than about 2.25, and then adding the ethylene diamine, ethyleneamine, or mixture of ethyleneamines.

To improve handling behavior, the flame retardant composition can be prepared by a method additionally comprising the step of pellitizing into particles of at least 30 microns in diameter on average and coating the flame retardant composition with a water resistant thermoplastic or thermoset.

The composition can be in any form such as fiber, film, coating, or solid object.

Other ingredients may be added to these compositions: For example, pigments are added for color. Mica, nano-clay, chopped glass, carbon fibers, aramids, and other ingredients can be added to alter mechanical properties. Other flame retardants both non-halogen and halogen can be added to form a flame retarded composition in order to capture synergies between different chemistries. Anti drip agents are fluorinated polymeric compounds that cause polymer compositions to resist dripping when subjected to flame retardance testing.

It was unexpected that the flame retardant compositions intumesce when subjected to a flame although no polyhydric component with hydroxyl groups is present, which is easily observed by subjecting flame retardant composition to propane torch. It was unexpected that the flame retardant compositions were much more stable than EDAP in that very little weight loss occurs at 250° C. relative to EDAP when heated in a vacuum oven for 20 minutes. It was even more surprising that flame retardant compositions made with pH between about 2.5 to 4.0 could be extruded at higher temperatures than those with higher pH. It was unexpected that many of the flame retardant compositions melt before decomposing. It is also unexpected that melting behavior enables the flame retardant compositions to easily blend into polymers such as polypropylene, polyethylene, polystyrene, NORYL® (a blend of polyphenylene oxide and polysytrene), nylon 6, and nylon 66 on what appears to be molecular dispersion as no particles are apparent, with similar behavior expected for other polymer groups. Molecular dispersion or very small particle dispersion apparently obtained here should provide more effective flame retardance. It was unexpected that an apparent synergy occurs when the flame retardant composition is added to polymers along with melamine and or melamine phosphates. It was unexpected that addition of an anti drip agent improves flame retardant behavior so that less flame retardant composition need be added. It was also unexpected that the composition consisting of the flame retardant composition, melamine pyrophosphate, anti drip agent and polypropylene could all be added together at the feed throat of a twin screw extruder and obtain flame retarded polymeric composition with excellent mechanical properties. It was also unexpected that by preparing polyphosphoric acid via ion exchange process, flame retardant compositions could be made that can be extruded at temperatures greater than 250° C., allowing their use in engineering polymers such as nylons and polyesters. The sum total of unexpected results provide a commercially useful halogen free flame retarded composition that can be processed over a wide temperature range.

### DETAILED DESCRIPTION OF INVENTION

The composition described herein is in its most general form the reaction product of ethylene diamine, ethyleneamines and optionally an amine with phosphoric, pyrophosphoric and/or polyphosphoric acid.

Ethyleneamines are defined here as polymeric forms of ethylene diamine with three or more nitrogen atoms and including piperazine and its analogues. A thorough review of ethylene diamine and ethyleneamines can be found in the Encyclopedia of Chemical Technology, Vol 8, pgs. 74-108. Ethyleneamines encompass a wide range of multifunctional, multireactive compounds. The molecular structure can be linear, branched, cyclic, or combinations of these. Examples of commercial ethyleneamines are diethylenetriamine (DETA), piperazine (PEP), triethylenetetramine (TETA), tetraethylenepentamine (TEPA), pentaethylenehexamine (PEHA), aminoethylpiperazine(AEP), and aminoethylethanolamine(AEEA). Other compounds which may be applicable are 1,2-propylenediamine, 1,3-diaminopropane, iminobispropylamine, N-(2-aminoethyl)-1,3-propylenediamine,N,N′bis-(3-aminopropyl)-ethylenediamine, dimethylaminopropylamine, and triethylenediamine.

Certain acids are difficult to obtain in very pure form. Pyrophosphoric and polyphosphoric acid can be contaminated with orthophosphoric acid unless freshly prepared as these two acids convert to orthophosphoric in aqueous medium, with the rate being dependent on many factors such as temperature, pH, and water content. Pyrophosphoric and polyphosphoric acid can be prepared from the appropriate pure sodium salts, tetra sodium pyrophosphate and sodium polyphosphate, using the acidic ion exchange resin: for example, AMBERLITE® 120H from Rohm and Haas, Philadelphia, Pa. An aqueous solution of the appropriate salt is passed through an ion exchange column containing AMBERLITE® 120H, at which time almost all the sodium ions are removed leaving the pure acid. The acidity of the prepared acid will depend on the extent to which the sodium ions were removed. Thus not all the sodium must be removed to prepare the flame retardants of the invention. The most preferred for strong acids is pH less than about 1.0.

Polyphosphoric acid, a commercially available form, can also be prepared by heating H₃PO₄ with sufficient phosphoric anhydride to give the resulting product, an 82-85% P₂O₅ content, as described in the Merck Index 10th edition, #7453. Such a polyphosphoric acid can be obtained from Aldrich Chemical or Rhodia Corporation and is used in several of the examples. Meta phosphoric acid can be purchased from Aldrich Chemical, Milwaukee, Wis. and is defined as (HPO₃)ₙ. The actual number of n units in a polymeric chain is not given.

Examples of suitable amine compounds are urea, substituted akyl ureas, thiourea, akyl thiourea, cyanamide, ethylenediurea, aniline, ethyleneamines, dicyandiamide, guanidine, guanamine, benzoguanamine, acetoguanamine, glycoluril, acrylamide, methacrylamide, melamine, benzene sulfonamide, naphthalene sulfonamide, toluene sulfonamide, ammeline, ammelide, guanazole, phenylguanazole, carbamoylguanazole, dihydroxyethyleneurea, ethyleneurea, propylene urea, melem (C₆H₆N₁₀), melam (C₆H₉N₁₁), octadecylamide, glycine, and their mixtures. The preferred amine is melamine.

Flame retardants are generally added to materials so that the material passes a particular flame retardance test. The test dictates the level of flame retardance and thus the level of addition. Many considerations are application dependent.

A best practice can not be formulated beforehand for all polymers. Polymers decompose at different temperatures thus requiring the flame retardant composition to be chosen with that information in hand. Polypropylene with little inherent char formation will flame retard differently than a polyester or a polyamide. Polymers within these families can behave very differently. Thermosets may have lower processing temperatures allowing use of flame retardant compositions that would decompose in an extruder.

The flame retardant compositions, especially the ones involving polyphosphates, can be quite soluble. Thus, they are recovered by evaporation techniques. The simplest approach is to use a vacuum oven to remove the solvent and obtain dry product. Another technique is to place the solution containing the product on a hot plate and then use a blow dryer to blow hot air on the stirred solution to remove the water. The pasty product is further dried in an oven with or without vacuum. For large scale production, commercially available equipment such as evaporators with scrubbers and condensers could be used. Porcupine processor could be used to completely dry the product once most of the water was removed with an evaporator. The only requirements are that the technique not substantially degrade the reaction product by drying too long at elevated temperature and that some mixing occur as the evaporation proceeds as there may be further reaction occurring during the solvent removal stage.

The preferred practice is to form the resinous flame retardant composition of DETA, TETA, or mixtures thereof with polyphosphoric acid. The most preferred is to use polyphosphoric acid obtained via ion exchange process to form the flame retardant compositions. The preferred ratio of acid to ethyleneamine is chosen so that the pH of the resultant flame retardant composition is about 2.5. to 4.0, with about 3.0 to 3.5 being most preferred. The product with pH about 3.0 to 3.5 can shown to be more stable than if the pH were higher at about 5, by its extrusion properties, as shown in the examples. Examples show that the lower pH flame retardant composition has superior extrusion properties due to better thermal stability and that the thermal stability is further improved by use of ion exchange prepared polyphosphoric acid. One of the advantages of flame retardant composition prepared with commercial polyphosphoric acid is it is less expensive to manufacture and cost is an important consideration. It is also most preferred to use flame retardant compositions that are resins in that they dissolve into the polymers. Commercial polyphosphoric acid contains some phosphoric acid contaminant according to the manufacturer, which could account for lower thermal stability compared to ion exchange prepared flame retardant composition. Polyphosphoric acid prepared with ion exchange may have very little phosphoric acid contaminant, because the sodium polyphosphate is thought to contain practically no sodium phosphate. Ion exchange prepared aqueous polyphosphoric acid separates into two liquid components on standing. This aqueous acid reacted with an ethyleneamine also separates into two liquid components on standing which are easily visible, suggesting more than one molecular weight. It would be expected that less pure polyphosphoric acid would be acceptable for many applications, and for reasons such as cost and possibly easier to make. For example, the polyphosphoric acid content should be such that at least 90% by weight has chain length n greater than or equal to 3. A polyphosphoric acid with at least 95% chain length greater than 3 would be preferred. A polyphosphoric acid with at least 99% chain length greater than 3 would be more preferred. Currently, the ion exchange resin prepared polyphosphoric acid is most preferred.

Such ethyleneamine/polyphosphoric acid flame retardant compositions were shown to be more stable than EDAP by heating in a vacuum oven for 30 minutes at 200° C. For flame retarding solid thermoplastic objects, addition of compounds such as melamine, melamine phosphate, dimelamine phosphate, melamine polyphosphate, melamine pyrophosphate (MPP), and mixtures thereof with the DETA/polyphosphoric flame retardant composition is preferred because of better molding properties. It is preferred to add about one to three parts MPP with two parts of the DETA/polyphosphoric flame retardant composition. For polypropylene, about a 30% total loading is preferred to obtain UL94 V0 classification in flame retardance testing. One part MPP with two parts DETA/polyphosphoric flame retardant composition is most preferred for flame retarded polypropylene solid objects. Another part of the best practice for olefin thermoplastic applications is to add an anti drip agent at a loading of 0.1 to 1%, with 0.25 to 0.5% most preferred. For some compositions, it may be preferred to use a flame retardant composition made with the higher molecular weight ethyleneamines such as TEPA, which might reduce potential mold deposit and blooming.

The flame retardant compositions made from phosphoric acid or pyrophosphoric acid were found to be fundamentally different than those made from polyphosphoric acid. The flame retardant compositions made with polyphosphoric acid were resinous in behavior in that they melted into the polymer when mixed in an extruder, an unexpected but useful behavior. The flame retardant compositions from phosphoric acid or pyrophosphoric acid made in an aqueous medium form a crumb or a powdery type material on removal of water and not a resinous product. The unexpected resinous behavior when mixed into polymers enables the formation of nearly clear polymeric thin films and the spinning into polymeric fibers which cannot be conveniently done for flame retardant compositions that remain as particles in the polymer. The flame retardant compositions from polyphosphates are more stable and can be extruded at much higher temperatures than the corresponding phosphate, which is desirable for higher melting polymers or to process lower melting compositions at higher rates.

Ethyleneamines are often made from an industrial method based on ethylene and ammonia, according to Encyclopedia of Chemical Technology, Volume 8, page 82. A typical product distribution is EDA 55%, piperazine (PIP) 1.9%, DETA 23%, amino ethylpiperazine (AEP) 3.5%, TETA 9.9%, TEPA 3.9%, and higher ethyleneamines 2.3%. Other methods for synthesis of ethyleneamines also give similar distributions of the ethyleneamines. All the commercial methods synthesize all ethyleneanines at same time, thus requiring separation. The least expensive method to make one of the flame retardant compositions is to use this mixture of ethyleneamines directly or just the fraction with a boiling point greater than EDA, for example. This will eliminate the costly step of separation and packaging of ethyleneamines into specific chemicals, which are then individually reacted with the acids and amines.

The flame retardants can be added to synthetic polymers, both thermoplastic and thermoset as well as polymeric coatings and paints. The field of applicability is not limited.

Flame retarded polymer compositions can be prepared conventionally in a melt mixer such as a Brabender mixer, a single screw extruder, a twin screw extruder, or any other such devise that melts polymer and allows addition of additives. A Brabender, Buss Kneader or Farrell mixer will be preferred for polymers with poor thermal behavior. An extruder is often used for more stable polymers with high melt point.

The extrusion properties are dependent on the thermal stability of the flame retardant composition. The flame retardant composition of DETA/polyphosphoric acid will be used to demonstrate guidelines for choice of flame retardant composition and the conditions were determined on a 28 mm twin screw extruder made by Werner and Pfleiderer. Larger machines may differ in detail of setting. The DETA/polyphosphoric acid flame retardant composition made with commercial polyphosphoric acid and a pH of 5.3 can be processed in 28 mm twin screw extruder with the barrel temperatures set as high as about 210° C. For similarly prepared material with a pH of about 3.0 to 3.5, the barrel temperatures can be raised to about 230° C. To process polymers at higher temperatures, it is most preferred to use the DETA/polyphosphoric acid flame retardant composition prepared with the ion exchange process and a pH of about 3.0 to 3.5. The barrel temperatures on a 28 mm twin screw extruder can then be set to 275° C. (barrel near feed), 275° C., 265° C., 265° C., 265° C., and 275° C. (at the die). Such temperatures enable processing of engineering polymers, for example NORYL®, nylon 6, and nylon 66. Higher barrel settings were not attempted as unneeded for these polymers.

Because the flame retardant compositions can absorb water, it may be advantageous to pellitize and coat with a water insoluble coating. Such a coating with or without pellitizing will decrease water absorption and make it easier to use. Such a coating could also be administered to the final product produced from the flame retarded resin composition to reduce or eliminate water absorption.

The flame retardant compositions can be resinous depending upon the ingredients. These resinous flame retardant compositions can mix into polymers and reduce the viscosity and thus the processing temperature and thereby serve as processing aids at low concentrations. In such situations, the lower processing temperature could allow addition of other flame retardants such as EDAP.

The range of application of the flame retardant compositions can be enlarged by decreasing the particle size by milling in a monomer or solvent. The milled compound in the monomer can then be added to the method for making the polymers containing that monomer and thereby making a polymeric composition that comprises a flame retardant. Examples include thermoplastic and thermoset polymers such as polyesters, polyamides, polyolefins, polyurethanes, and their copolymers. Thermosets for electronic packaging are often prepared from a solvent solution with the solvent being organics such as the ketones (methylethyl ketone). Electronic packaging involves multilayer films and adhesives, with the total package required to pass particular flame retardant tests. Our flame retardant compositions mllled in a solvent, where the flame retardant is insoluble, could be added to the thermoset solution and then cured in standard fashion.

The classes of polymers to which the flame retardant compositions are applicable include the following: acrylic, butyl, cellulosics, epoxy, furan, melamine, neoprene, nitrile, nitrocellulose, phenolic, polyamide, polyester, polyether, polyolefin, polysulfide, polyurethane, polyvinyl butyral, silicone, styrene-butadiene, butyl rubber, polyethylene naphthalate, and vinyl.

Polymer and polymer compositions to which the flame retardant compositions of the invention are applicable to include the following:
1. Mono and diolefins such as polypropylene(PP), thermoplastic olefins (TPO), polyisobutylene, polymethylpentene, polyisoprene, polybutadiene, polyethylene with or without crosslinking, high density polyethylene, low density polyethylene, or mixtures of these polymers. Copolymers of mono and diolefins including other vinyl momomers such as ethylene-propylene copolymers, ethylene-vinyl acetate copolymers. Terpolymers of ethylene with propylene and a diene such as hexadiene, cyclopentadiene or ethylidiene norborene and vinyl monomers such as vinyl acetate. Mixtures of polymers under 1.
2. Polystyrene, poly p methyl styrene, poly a methylstyrene, and copolymers of styrene or α methylstyrene with dienes or acryl derivatives such as styrene-butadiene, styrene-actrylonitrile, styrene-alkylmethylacrylate, styrene-butadiene-akylacrylate, styrene-maleic anhydride, and styrene-acrylonitrile-methylacrylate, syndiotactic polystyrene.
3. Polyphenylene oxide and polyphenylene sulfide and their mixtures with styrene polymers or with polyamides.
4. Polyurethanes derived from polyethers, polyesters and polybutadiene with terminal hydroxy groups on one hand and aliphatic or aromatic polyisocyanates on the other as well as their precursors.
5. Polyamides and copolymers derived from diamines and dicarboxylic acids and/or from aminocarboxylic acids or the corresponding lactams, such as polyamide 4, polyamide 6, polyamide 6/6, 6/10, 6/12, 4/6, 66/6, 6/66, polyamide 11, polyamide 12, aromatic polyamides based on aromatic diamine and adipic acid: and iso- and/or terephthalic acid and optionally an elastomer as modifier, for example poly-2,4-trimethyl hexamethylene terephthalamide, poly m phenylene-isophthalamide.
6. Polyesters derived from dicarboxylic acids and dialcohols and/or from hydrocarboxylic acids or the corresponding lactones such as polyethylene terephthalate, polybutylene terephthalate, polyethylene terephthalate/polybutylene terephthalate mixtures, polyethylene terephthalate/polybutylene terephthalate copolymers, poyl 1,4-dimethyl clclohexane terephthalate, polyhydroxybenzoates, and co-polymers with ethylene.
7. Polyvinyl chloride and copolymers with ethylene, copolymers of tetra fluro ethylene and ethylene.
8. Thermoset polymers include for example unsaturated polyester resins, saturated polyesters, alkyd resins, amino resins, phenol resins, epoxy resins, diallyl phthalate resins, as well as polyacrylates and polyethers containing one or more of these polymers and a crosslinking agent. A review of thermosets is found in Ullmann's Encyclopedia of Industrial Chemistry, Vol A26, p 665.
9. Polymers for insulation such as fluorinated ethylene-propylene (FEP), cross linked polyethylene (XLPE), ethylene-propylene rubber (EPR), tree cross linked polyethylene (TRXLPE), and ethylene vinyl acetate (EVA).
10. Cellulose acetate, flexible polyurethane, rigid polyurethane.
11. Fluoropolymers and co-polymers such as TEFZEL®, DuPont Co, Wilmington, Del. Elastomers such as SPANDEX® as defined in Encyclopedia of Chemical Technology. Polyimides such as KAPTON®, DuPont Co., Wilmington, Del. And defined in Encyclopedia of Chemical Technology.
12. Ethylene vinyl acetate, ethylene methyl, ethyl, and butyl acrylate ethylene (methyl, ethyl, buthyl) acrylate, ethylene n butyl acrylate glycidyl methacrylate, -ethylene vinyl acetate carbon monoxide, ethylene n butyl acrylate carbon monoxide, vinyltrimethylsilane, or vinyltriethylsilane ethylene methyl acrylate, ethylene methyl acrylate, ethylene acrylic and methacrylic acid, ethylene acrylic and methacrylic acid ionomers (Zn, Na, Li, Mg), maleic anhydride grafted polymers.

Melamine pyrophosphate and mono, di-, or tri-pentaerythritol are commonly used together (see U.S. Pat. No. 3,914,193) with a film forming latex of a poly(vinyl ester) to form an intumescent latex coating composition or intumescent paint or could be used to make latex backing for carpets. Such latex's can be in aqueous or alcohol mediums. An improvement is to use the self intumescing reaction products of the invention with the latex binder to form coatings or paints that are flame retardant coatings. A usable coating can contain one or more of the other ingredients such as potassium tripolyphosphate, ethhoxylated castor oil, waxy-fatty ester de-foamer, chlorinated paraffin, TiO₂, and hydroxy ethyl cellulose which are normally ingredients in flame retardant paints. One skilled in the art of coatings can easily add the correct combinations to get proper physical behavior of a coating or carpet backing with the compounds of the invention.

The materials of the invention have value for flame retarding articles, films, and fibers.

If desired, the flame retarded polymeric compositions of the present invention can be stabilized by addition of a phenol antioxidant, a phosphorous antioxidant, a thio-ether antioxidant, an ultraviolet absorber, a hindered amine light stabilizer, and the like.

The flame retarded polymeric compositions of the present invention can contain further various additives. Useful additives include nucleating agents, such as aluminum p-t-butylbenzoate, aromatic phosphoric ester metal salts, and dibenzylidene sorbitals, metal soaps, hydrotalcites, triazine ring-containing compounds, other inorganic phosphorous flame retardants, halogen flame retardants, silicone flame retardants, fillers, pigments, lubricants, and blowing agents. Additives such as melamine or silica may reduce the possible hydroscopic tendency of polymers flame retarded with the flame retardant composition of this invention.

Articles are often made in hot molds or forced through hot dies. There may be residue or contaminants that require removal. It may be useful to remove volatile constituents from articles made from the flame retarded polymeric compositions by heating to a temperature between about 30° C. and 150° C. for between about 0.5 minute to 360 minutes. It may be useful to coat or paint the final articles prepared from the compositions of this invention to protect from moisture depending on the use.

The flame retarded polymer composition may contain other additives such as other flame retardants, standard carbon forming compounds, and re-enforcing agents, a partial list being chopped glass, aramid fibers, talc, mica, nano-clay, or clay. Since flame retardants work by different mechanisms, a combination of our flame retardant composition with other flame retardants may perform more efficiently. Other additives include such ingredients as stabilizers, release agents, flow agents, dispersants, plasticizers, anti-drip agents, and pigments.

The flame retardant resin composition of the present invention is not limited in use. For example, the flame retarded resin composition has variety of applications as wire and cable insulation on conductor wires, cable jackets, machine mechanical parts, electric or electronic parts, and automobile parts. Examples of applications include electric and electronic parts, such as gears, cases, sensors, LEP lamps, connectors, sockets, resistors, relay cases, switches, coil bobbins, condensers, variable condensers, light pickups, oscillators, terminal boards, transformers, plugs, printed wiring boards, tuners, speakers, microphones, headphones, small-sized motors, magnetic head bases, power modules, housings, semiconductor devices, liquid crystal devices, FDD carriages, FDD chassis, motor brush holders, parabolic antennas, and computer related parts, domestic and office appliances, such as VCR's, television sets, irons, hair dryers, rice cookers, micro wave ovens, audio visual media (laser disks and compact dicks), lighting fixtures, refrigerators, air conditioners, typewriters, word processors, office computers, telephones, facsimiles, copiers, machine related parts such as washing jigs, various bearings, motors, lighters, typewriters, optical equipment, microscopes, binoculars, cameras, watches, alternator terminals, alternator connectors, IC regulators, potentiometer bases, various valves, fuel pipes, exhaust pipes, air intake snorkels, intake manifolds, fuel pumps, engine cooling water joints, carburetor spacers, exhaust sensors, cooling water sensors, oil temperature sensors, brake pad wear sensors, air flow meters, alternating current (AC) thermostat bases, AC warm air flow control valves, brush holders for radiator, water pump impellers, turbine vanes, wiper motor parts, distributors, starter switches, starter relays, transmission wire harness, window washer nozzle, AC panel switch board, coils for fuel related electromagnetic valves, fuse connectors, horn terminals, insulators for electric parts and accessories, rotors for step motors, lamp sockets, lamp reflectors, brake pistons, solenoid bobbins, engine oil filters, ignition unit cases: housings of personal computers, printers, displays, CRT's, facsimiles, copiers, word processors, notebook computers, and memories of DVD drives, PD or floppy disk drives: other molded articles; films, filaments: and fibers.

Items made with the composition of this invention may require a surface sealant. A paint adhesion promoter for plastics such as BOND AID® or similar product available in retail paint stores can be used to coat the item and even add a second surface coating for more complete sealing of the surface.
Sources of Materials:

Melamine was obtained from DSM Corp., Saddlebrook, N.J.

PCS Inc., Newark, N.J. for 85% concentration phosphoric acid.

Meta-phosphoric acid, polyphosphoric acid, sodium acid pyrophosphate, sodium polyphosphoric acid, DETA, TETA, TEPA, and EDA were obtained from Aldrich Chemical, Milwauke, Wis. Polyphosphoric acid also obtained from Rhodia Corporation, St. Louis, Mo.

FR150 from Shamrock Technology, Newark, N.J.

NORYL®, General Electric Co., Schenectady, N.Y.

BOND AID® from W. M. Barr & Co., Inc., Memphis, Tenn.

### EXAMPLES

Polyphosphoric acid is quite expensive compared to sodium polyphosphate, available from Tilley Chemical Corp., Baltimore, Md. Polyphosphoric acid can be made by dissolving sodium polyphosphate in water and then extracting the sodium ions with an ion-exchange resin (AMBERLITE® 120 from Aldrich Chemical) to form polyphosphoric acid.

The flame retardant composition (sample #7ionex) demonstrates feasibility for engineering polymers. First, 2640 g of sodium polyphosphate was dissolved in 15.4 L of water. The solution was processed through an ion exchange column to obtain polyphosphoric acid. The DETA/polyphosphoric acid flame retardant composition was prepared by adding 700 g of DETA to the polyphosphoric acid solution. The water was partially evaporated to yield a resinous, pasty product, which was further dried in a vacuum oven. The sample shows substantial intumescense when heated with a propane torch.

Examples with NORYL®, nylon 6, and nylon 66 were prepared to demonstrate good thermal stability of composition #7 ionex. The barrel temperatures on the 28 mm Werner and Pfleiderer twin screw extruder were set at (starting at the barrel near main feed) 275° C., 275° C., 265° C., 265° C., 265° C., and 275° C. (at die). The screw speed was 250 rps. Compositions were prepared by adding nylon 6, nylon 66, or NORYL® pellets in the feed throat. The flame retardant #7ionex was added at the side feeder at a concentration of 25% for nylon 6 and nylon 66 and a concentration of 15%-20% for NORYL®. All three compositions ran well and the polymeric pellets showed no sign of foaming, an indicator of stability of flame retardant composition. Bars of 3.2 mm thickness were molded and subjected to a 20 mm flame from a methane Bunsen burner as in a UL94 test for 10 seconds. All samples did not ignite when subjected to a 10 second burn. The NORYL® sample did not ignite even subjected to a second and third burn indicating it would pass UL94 testing at a V0 rating. The elongation of tensile bars were estimated to be about 5-10%. Some of these bars were coated with BONDAID. A nice surface resulted that could be left as is or painted.

A second synthesis was performed with the ion exchange column. However, 900 g of DETA was added so that the pH of the solution was about 5.4. The solution was evaporated and dried as with #7 ionex. The extruder had the same barrel settings as before, 275° C., 275° C., 265° C., 265° C., 265° C., and 275° C.(at die). The nylon 6 product out of the extruder was of poor quality in that the pellets were foamed. The flame retardance of bars made with this material was the same as previous example but the bars were more brittle and contained voids. These two examples demonstrate the improved performance of the lower pH flame retardant composition with polyphosphoric acid from the ion exchange process.

The next two examples were prepared with DETA and commercial polyphosphoric acid from Rhodia Corporation, St. Louis, Mo. First, 250 g of polyphosphoric acid were placed in two separate aluminum pans. Next, 170 g of DETA and 145 g of water were mixed together and then added to pan #1 containing 250 g polyphosphoric acid. To pan #2, 130 g of DETA and 130 g of water were added. Each pan was mixed slowly with a wooden rod to enable the reactions to go to completion in both pans. Some DETA escapes due to substantial heat release. Two resinous products were obtained which were poured into aluminum pans and dried in a vacuum oven at 150° C. The first product had a pH of about 5.3, and the second product had a pH of about 3.5. The products were mixed into polypropylene on the 28 mm twin screw extruder at a loading of 25%. The flame retardant was added at the side feed. The first product with higher pH required the barrel settings not to exceed 210° C. or foaming occurred. The lower pH product was run with barrel settings of 230° C., without any evidence of foaming. The products molded well and did not ignite when subjected to a 20 mm methane flame for 10 seconds. The elongations were about 10%. The lower pH flame retardant composition performs better than the one with higher pH. Also, the materials prepared with commercial polyphosphoric acid could not be run with the extruder barrels set at temperatures above 250° C. or some foaming occurred.

In this example, a mixture of melamine polyphosphate with the TETA salt of polyphosphoric acid was prepared. First, 3 g of melamine was added to 15 g of water and heated to about 80° C. About 18 g of polyphosphoric acid was added and reacted for about 15 minutes at which time some melamine polyphosphate has been made. Then, TETA was added to bring the mixture to pH of about 3.5. Then, the mixture was dried in a vacuum oven. Other amines such as urea, guanidine, and dicyandiamide could be used in place of melamine.

In this example, 60.1 g of sodium acid pyrophosphate was processed through an ion exchange column to form pyrophosphoric acid. EDA was then added to obtain a pH of about 5.5. The water was mostly removed by partially evaporating with hot air while the solution was mixed on a hot plate. The sample was then dried in a vacuum oven. The resultant flame retardant composition consisted of particles, and the drying process was much more rapid than for resinous flame retardant composition made with polyphosphoric acid. By heating in a vacuum oven at 250° C. for 20 minutes and measuring the weight loss, the EDA and pyrophosphoric acid product was found to be less thermally stable than that of EDA and polyphosphoric acid.

In this example, 30 g of 85% concentration phosphoric acid was diluted to a concentration of about 60% by weight. DETA was added to obtain a pH of about 5.5. The solution was dried. The flame retardant composition consisted of particles and was much easier to extract than for a resin. By heating in a vacuum oven at 250° C. for 20 minutes and measuring the weight loss, the DETA and phosphoric acid product was found to be less thermally stable than that of DETA and polyphosphoric acid.

Another preferred composition for applications requiring extrusion was made with the 22 L column. First, 2640 g of sodium polyphosphate was dissolved in 15.4 L of water. The solution was processed through the ion exchange column to obtain polyphosphoric acid. The polyphosphoric acid solution was divided into three equal parts. Sample 5-1 was prepared by adding 320 ml of TETA to one third of the polyphosphoric acid solution. Sample 5-2 was prepared by adding 320 ml of DETA to one third of the polyphosphoric acid solution. Sample 5-3 was prepared by adding 200 ml of EDA and 100 ml of TETA to one third of the polyphosphoric acid solution. The water was evaporated for all three samples to yield resinous, pasty products which were further dried in a vacuum oven. All three samples were found to be much more stable that EDAP when heated in a vacuum oven. The three samples all show substantial intumescense when heated with a propane torch.

A composition for extrusion was prepared by mixing together by weight 70% polypropylene pellets, 20% sample 5-2, and 10% melamine pyrophosphate. The mixture was compounded in a 25 mm Werner and Pfleiderer twin screw extruder with the barrel temperatures set at 180° C. and screw speed of 150 rps. The mixture was added to the extruder at the main feed throat to demonstrate good thermal behavior, especially as the extruder had a standard screw design to melt and mix the composition. The resultant composition was molded into tensile bars 3.2 mm thick and flex bars 1.6 mm thick. The bars have elongation of about 6%. The flex bars were subjected to two 10 second burns with a methane Bunsen burner and passed, which indicates that the flex bars would pass UL94 testing with a V0 rating. The presence of MPP apparently makes molding good quality bars easier.

Another composition was prepared by mixing together by weight 69% polypropylene pellets, 20% sample 5-2, 10% melamine, and 1% FR150. The same procedure was followed on 25 mm twin screw extruder. Molded bars gave an elongation of about 10% and the bars pass our approximate UL94 testing with a rating of V0 at 1.6 mm thickness. The presence of melamine also makes molding good quality bars easier. The best practice probably will be addition of a combination of melamine and melamine pyrophosphate.

Another composition was run by mixing together 60% polystyrene pellets, 27% sample (5-2), and 13% MPP and compounded on the 28 mm extruder. The bars with a thickness of 3.2 mm easily pass our qualitative UL94 testing.

Dow Chemical Company makes EDA and ethyleneamines consisting of mixtures with high boiling points that should work well according to the teaching of this patent. For example Dow Chemical sells a product called tetraethylenepentamine-UHP which is a mixture of four different pentamines and additional higher and lower molecular weight ethyleneamines and their analogues, all with similar boiling points including linear, branched and two cyclic pentamines.

Another high boiling point Dow product suitable here is heavy polyamine X (HPA-X) which is a complex mixture of linear, branched, and cyclic ethyleneamines, the structure of which can be deduced from the chemistry of manufacture and a knowledge of the structures present in TETA and TEPA.

1. A flame retardant composition prepared by reacting ethylene diamine with polyphosphoric acid; or by reacting an ethyleneamine or mixture of ethyleneamines with an acid selected from the group consisting of phosphoric acid, polyphosphoric acid, pyrophosphoric acid, and mixtures thereof; in which the ratio of the acid or acid mixture to the ethylene diamine, the ethyleneamine, or the mixture of ethyleneamines is such that a 10% solution of the flame retardant composition in water has a pH between about 2.5 to 6.0.

2. The composition of claim 1 where the pH is between about 2.5 to 4.0.

3. The composition of claim 1 where the pH is between about 2.5 to 3.0.

4. The composition of claim 1 in which:
the method comprises the step of reacting the ethyleneamine or mixture of ethyleneamines with the acid or acid mixture; and
the ethyleneamine or mixture of ethyleneamines is selected from the group consisting of diethylenetriamine, triethylenetetramine, tetraethylenepentamine, pentaethylene examine, and mixtures thereof.

5. The composition of any of claim 1 in which the flame retardant composition is prepared by a method additionally comprising the steps of
initially reacting melamine with the acid or mixture of acids so that the pH of a 10% solution in water of the product formed thereby is less than about 2.25, and
then adding the ethylene diamine, ethyleneamine, or mixture of ethyleneamines.

6. The composition of any of claim 1 in which:
the method comprises the step of reacting the ethyleneamine or mixture of ethyleneamines with the acid or acid mixture; and
the ethyleneamine or mixture of ethyleneamines is a mixture of ethyleneamines with a boiling point greater than or equal to that of ethylene diamine.

7. The composition of claim 1 in which the method additionally comprises the steps of pellitizing the flame retardant composition into particles of at least about 30 microns in diameter on average and coating the particles with a water resistant thermoplastic or thermoset.

8. The composition of claim 1 in which the acid is polyphosphoric acid.

9. The composition of claim 8 wherein the acid is polyphosphoric acid prepared via ion exchange.

10. The compositions of claim 8 wherein at least 90% by weight of the polyphosphoric acid has a chain length n greater than or equal to 3.

11. The composition of claim 10 wherein at least 95% by weight of the polyphosphoric acid has n≧3.

12. The composition of claim 10 wherein at least 99% by weight of the Dolyphosphoric acid has n≧3.

13. A composition comprising:
a) 30 to 99.75 percent by weight of a polymer; and
b) 0.25 to 70 percent by weight of the flame retardant composition of claim 1.

14. The composition of claim 13 additionally comprising: (1) 0.05 to 1% of an anti drip agent relative to weight of composition: (2) 4.0 to 50%, by weight of composition, amines selected from the group consisting of melamine, melamine phosphate, dimelamine phosphate, melamine pyrophosphate, melamine polyphosphate, or (3) a mixture thereof.

15.-18. (canceled)

19. A composition comprising about 50 to 99% by weight of the composition of claim 13, and about 1 to 50 percent by weight of a reinforcing agent selected from the group consisting of glass, carbon, mica, aramid fibers, clays, nano-clay, and mixtures thereof.

20. Article and fibers made from the compositions of claim 13 heated to a temperature between about 30° C. and 150° C. for between about 0.5 minute to 360 minutes.

21. The composition of claim 3 in which the acid is polyphosphoric acid.

22. The composition of claim 21 wherein the acid is polyphosphoric acid prepared via ion exchange.

23. The compositions of claim 22 wherein at least 90% by weight of the polyphosphoric acid has chain length n greater than or equal to 3.

24. The composition of claim 23 wherein at least 95% by weight of the polyphosphoric acid has n≧3.
